(19) United States
(12) Patent Application Publication
(10) Pub. No.: US 2002/0188872 A1
(43) Pub. Date: Dec. 12, 2002

(54) Secure key entry using a graphical user inerface

(76) Inventor: Tandy G. Willeby, Dallas, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 09/874,274

(22) Filed: Jun. 6, 2001

(51) Int. Cl. H04L 9/32

(52) U.S. Cl. 713/202

(57) ABSTRACT

A system, method, and computer program product which allows passwords, passcodes, PINs, and other secure information to be entered into a graphical user interface without interception. The user enters the secure code by moving a cursor and selecting characters or symbols on a GUI screen, through the use of a mouse, touchscreen, lightpen, or other conventional device. Between each selection, the GUI characters and symbols are re-arranged on the GUI screen, so that even if the user's cursor manipulation is captured, the secure code cannot be reconstructed or reproduced. The preferred embodiment is particularly drawn to a secure system, method, and computer program product for entering a PIN number in an automated teller machine (ATM) application running on a data processing system.

### TECHNICAL FIELD

The present application relates to a system and method for receiving a secure input from a user via a graphical user interface.

### DESCRIPTION OF THE RELATED ART

Personal accounts have become an omnipresent aspect of contemporary society, associated with almost every aspect of our lives. Personal accounts are associated with, for example, telephone calling cards, checking and savings accounts in banks, computer networks, and credit cards. Typically, account security is maintained (and unauthorized access prevented) by use of a password or personal identification number (PIN).

Account security is maintained by requiring two separate steps for account access. First, the account number must be entered. Second, a password or PIN associated with the account must be entered as well. The account number is typically not concealed (i.e., it may be printed on the telephone calling card or credit card, or it may be recorded on a magnetic strip affixed to the card which is read by an associated card reader) and may be considered, at least for security purposes, to be readily accessible. In contrast, a password or PIN is not supposed to be readily accessible. Rather, a user is typically instructed to memorize and not write down a password or personal identification number to prevent inadvertent disclosure of the password or PIN. By keeping the password or PIN confidential, unauthorized access to an account is hopefully prevented.

For example, a telephone calling card number may be provided by keying in the number on a telephone keypad or, in some circumstances, sliding the telephone calling card through a magnetic card reader attached to a specially equipped telephone. The account number is printed on the telephone calling card, and accordingly is readily accessible to any individual looking at the telephone calling card. However, merely knowing the account number does not allow someone to use the telephone calling card since a caller also has to know the PIN associated with the telephone calling card before a call may be placed using the telephone calling card. In theory, someone who steals the telephone calling card or merely knows the account number printed on the telephone calling card cannot make fraudulent telephone calls using the telephone calling card account because only the authorized user knows the PIN necessary to activate the account.

Similarly, an automatic teller machine (ATM) access card has at least one account number associated with it which is normally recorded on a magnetic strip affixed to the card that is read when the card is inserted into the automatic teller machine. Again, unauthorized use of the card (and therefore unauthorized account access) is theoretically prevented by requiring entry of a personal identification number before an account identified on the card can be accessed to, for example, withdraw money from the account. The owner of the ATM access card is normally instructed to memorize the PIN and not write it down to prevent an unauthorized user from learning the PIN.

With respect to telephone calling cards and ATM access cards, a user will typically recall the PIN associated with the account and enter the PIN by pressing numeric buttons on a keypad At that instant, the secrecy of the PIN, which was stored only in the user's memory and therefore undetectable, evaporates. Any individual who can see the user entering the PIN can note the PIN as it is punched into the keypad and thereafter knows the PIN for the account.

Computer networks also have user accounts and associated passwords. For example, a user may have an electronic mail account or, as is increasingly often the case, the user may have a personal account associated with a home page of the World Wide Web accessed through the Internet. Typically, the user's account number may be readily obtained but unauthorized access to the user's account is restricted by requiring entry of a password or personal identification number before access to the account is granted. For example, a computer user may have a stock trading account with a stock broker that maintains a web page. The user's account is not accessible without entry of an identification number, which is normally keyed in by the user at a remote terminal. As with other multiple level security systems using passwords or personal identification numbers, the identification number may be detected by an observer. In this case, the observer may be simply watching the keyboard or, alternatively, the observer may be using a so-called “sniffer” to observe the network traffic.

Another area where computer networks rely upon passwords for security is general network access. For example, many networks maintain a file for each user in which the user's various network account numbers (i.e., log in names) and associated passwords are maintained in a plain text file (e.g., rhost). This allows a user who has logged in to the network from her primary terminal to access various associated networks without having to repeatedly enter her user name and password for each access to an associated network. Although this system greatly enhances the ease with which a user can traverse network elements, it provides an opportunity for abuse if a computer hacker obtains access to the file information. At that point, the computer hacker can, at a minimum, view files to which he is not authorized for access. In worst case scenarios, the unauthorized user may destroy files or, under the guise of being an authorized user, otherwise damage the system or the authorized user's reputation.

In yet another application, a personal identification number or password is used in connection with voice mail. In a typical voice mail system, a user will enter the voice mail account number, typically the user's extension number, and then will be prompted to enter an access code of some kind. It is only by entering the appropriate access code (a PIN or password) that the user is able to listen to his or her voice mail. Thus, the user is able to maintain a degree of confidentiality with respect to her voice mail.

Each of these applications suffers from a common flaw. A casual observer or a dedicated intruder can detect the supposedly secret personal identification number or password, either by direct observation or by repeated trial attempts. Having determined what the personal identification number or password is, an unauthorized person can obtain access to the account with relative ease, having bypassed one of the security mechanisms intended to prevent such abuse.

For example, a telephone calling card can be readily abused by a thief observing an authorized user enter the calling card number and the personal identification number and recording the numbers as they are entered on the telephone keypad. The thief can then place hundreds if not thousands of dollars worth of unauthorized telephone calls.

Alternatively, a thief can watch a bank customer enter her personal identification number in an automatic teller machine and then steal the automatic teller machine access card from the bank customer. Because the thief knows the personal identification number, the thief can easily access all of the customer's bank accounts and the security provided by the personal identification number is easily defeated.

These access problems are exacerbated when an account is accessed over a computer system. In this case, both the account number and the passcode or PIN are directly entered into the computer system by the user, generally without the use of a magnetic-strip card or other medium, so they are both more easily intercepted. Further, there now exist many different means for capturing and recording keystrokes on a computer system, so that they can be later analyzed for account numbers and passcodes. Even more troublesome is the present capability to track the motion of a mouse or cursor on a graphical user interface (GUI) screen, and to record the screen location of touch-screen inputs, so that account numbers and passcodes can be determined my reconstructing the authorized user's actions on the GUI screen.

It would therefore be desirable to provide a system and method whereby account numbers, passwords, PINs, or passcodes can be entered through a GUI system with increased security.

### SUMMARY OF THE INVENTION

It is therefore one object of the present invention to provide an improved system, method, and computer program product for receiving passcodes through a graphical user interface.

The foregoing objects are achieved as is now described. The preferred embodiment provides a system, method, and computer program product which allows passwords, passcodes, PINs, and other secure information to be entered into a graphical user interface without interception. The user enters the secure code by moving a cursor and selecting characters or symbols on a GUI screen, through the use of a mouse, touchscreen, lightpen, or other conventional device. Between each selection, the GUI characters and symbols are re-arranged on the GUI screen, so that even if the user's cursor manipulation is captured, the secure code cannot be reconstructed or reproduced. The preferred embodiment is particularly drawn to a secure system, method, and computer program product for entering a PIN number in an automated teller machine (ATM) application running on a data processing system.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIG. 1 depicts a block diagram of a data processing system in accordance with a preferred embodiment of the present invention;

FIGS. 2A and 2B show exemplary GUI keypad entry images, in accordance with a preferred embodiment of the present invention; and

FIG. 3 depicts a flowchart of a process in accordance with a preferred embodiment of the present invention.

### DETAILED DESCRIPTION OF THE PREFERRED EMBODIMENTS

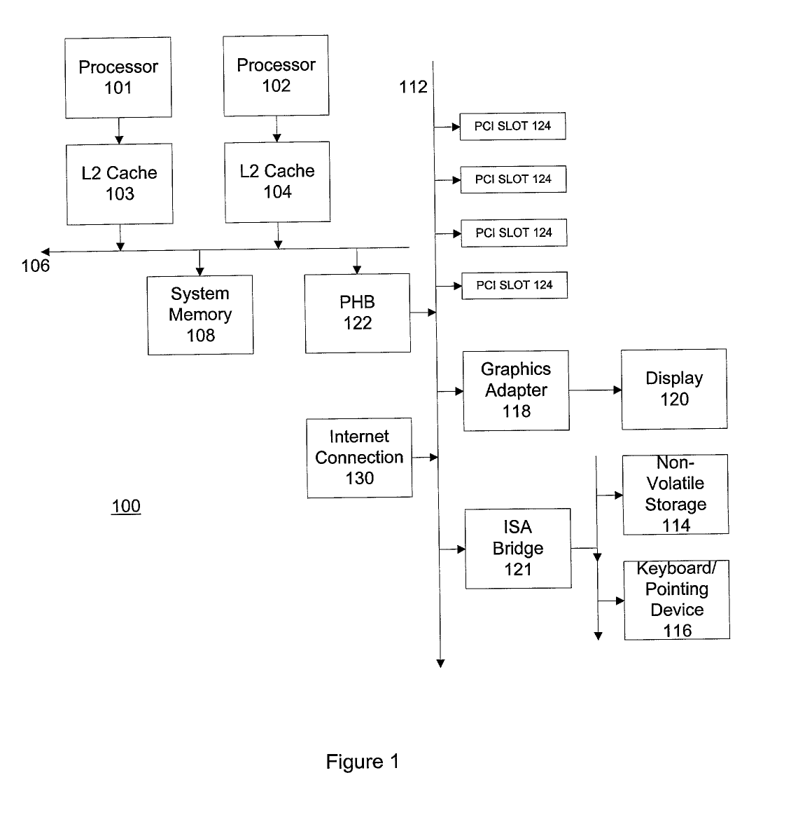

The numerous innovative teachings of the present application will be described with particular reference to the presently preferred embodiment (by way of example, and not of limitation). With reference now to the figures, and in particular with reference to FIG. 1, a block diagram of a data processing system in which a preferred embodiment of the present invention may be implemented is depicted. Data processing system 100 includes processors 101 and 102, which in the exemplary embodiment are each connected to level two (L2) caches 103 and 104, respectively, which are connected in turn to a system bus 106.

Also connected to system bus 106 is system memory 108 and Primary Host Bridge (PHB) 122. PHB 122 couples I/O bus 112 to system bus 106, relaying and/or transforming data transactions from one bus to the other. In the exemplary embodiment, data processing system 100 includes graphics adapter 118 connected to I/O bus 112, receiving user interface information for display 120. Peripheral devices such as nonvolatile storage 114, which may be a hard disk drive, and keyboard/pointing device 116, which may include a conventional mouse, a trackball, or the like, are connected via an Industry Standard Architecture (ISA) bridge 121 to I/O bus 112. PHB 122 is also connected to PCI slots 124 via I/O bus 112.

Also connected to I/O bus 112 is internet connection 130. This connection can be implemented in any number of ways, including an analog modem, a cable modem, xDSL, T1, a wireless device, and others.

The exemplary embodiment shown in FIG. 1 is provided solely for the purposes of explaining the invention and those skilled in the art will recognize that numerous variations are possible, both in form and function. For instance, data processing system 100 might also include a compact disk read-only memory (CD-ROM) or digital video disk (DVD) drive, a sound card and audio speakers, and numerous other optional components. All such variations are believed to be within the spirit and scope of the present invention. Data processing system 100 and the exemplary figures below are provided solely as examples for the purposes of explanation and are not intended to imply architectural limitations. In fact, this method and system can be easily adapted for use on any programmable computer system, or network of systems, on which software applications can be executed. A data processing system as described above can function both as a client system and a server system in the embodiments described below, when connected to a computer network such as an intranet or the Internet. Of course, the data processing systems described below, and in particular the client data processing system, may be implemented in a mobile telephone, a handheld system such as a personal digital assistant, or other portable or handheld data processing system, as long as it can perform the claimed functions.

The preferred embodiment provides a system, method, and computer program product which allows passwords, passcodes, PINs, and other secure information to be entered into a graphical user interface without interception. The user enters the secure code by moving a cursor and selecting characters or symbols on a GUI screen, through the use of a mouse, touchscreen, lightpen, or other conventional device. Between each selection, the GUI characters and symbols are re-arranged on the GUI screen, so that even if the user's cursor manipulation is captured, the secure code cannot be reconstructed or reproduced. The preferred embodiment is particularly drawn to a secure system, method, and computer program product for entering a PIN number in an automated teller machine (ATM) application running on a data processing system.

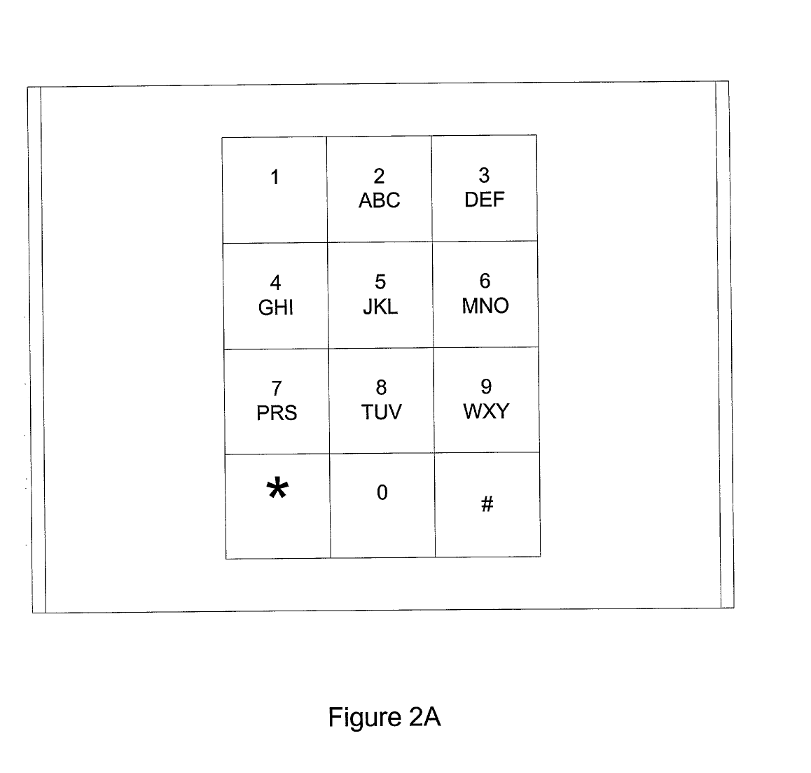

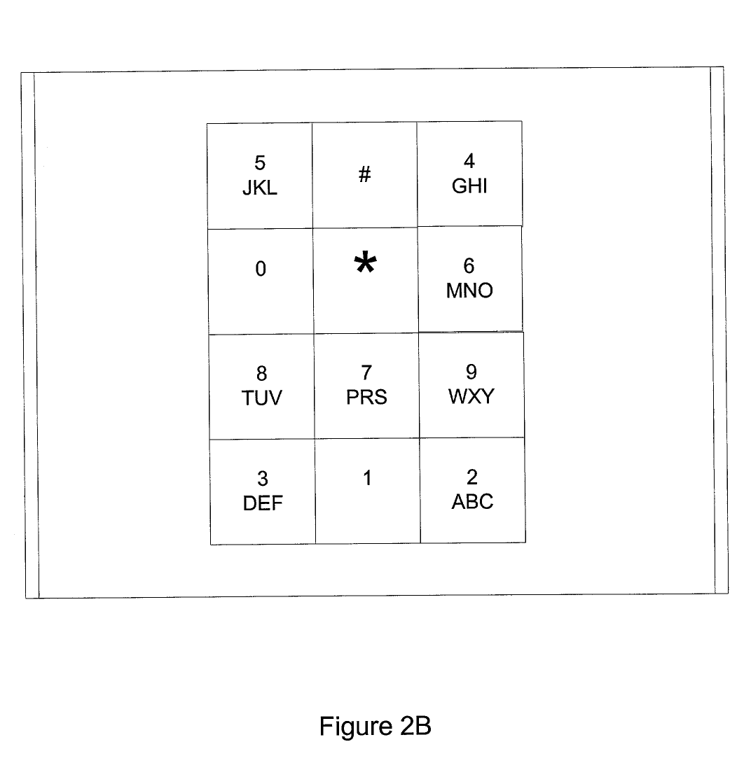

FIG. 2A shows a GUI representation of a conventional “keypad” entry system, with each key in its conventional location. In FIG. 2A, each graphically-represented key represents the numbers, letters, and special characters of a typical telephone-keypad entry system, as is typically used for inputting PIN numbers and passcodes on devices such as ATMs. While this format provides for an immediately recognizable and simple entry system, the codes entered on this graphic keypad are subject to interception, even when using a cursor-manipulation input method as opposed to an actual direct entry, as the motion of the cursor can be tracked and recorded. Later, the recorded cursor motions can be combined with the known screen locations of each graphic key to reproduce the passcode or PIN.

FIG. 2A shows a GUI representation of a keypad entry system, with each key in a new location, the locations of which are assigned, in the preferred embodiment, in a pseudo-random manner. In this figure, the user can still enter the same passcode or PIN number, but will select each key from its new location.

The preferred embodiment provides that a new keypad is generated after each key entry, with the graphically-represented keys in a different, pseudo-random location. By doing so, the user can manipulate the cursor, using a keyboard, mouse, or other input device, to select each character, number, or symbol in his passcode. After each character is selected, the GUI keypad is rearranged for the next character entry.

According to the preferred embodiment, the graphical keypad is generated by the server system and delivered and displayed on the client system. The graphical keypad is sent from the server to the client as a mappable graphic image, which combines all the selectable “keys” in a single image. Because all of the keys are combined in a single image, nothing on the client system, or in the client's browser software, can associate any portion of the graphic image with any specific symbol or character displayed in that image. When the user selects a “key” on the graphic image, the client system will return to the server system a code or coordinate indicating where, on the graphic image, that the user has selected. Of course, in an alternate embodiment, the keypad image itself can be comprised of multiple smaller images, such as multiple images of individual “keys” being combined into a larger “keypad” image.

When the server receives this code or coordinate, it will determine, according to the pseudo-random map that had been sent to the client, which character or symbol that the user entered. Since the association between the image and the individual symbols or characters represented by the image is only made on the server-side, it is impossible to intercept or reconstruct the passcode or PIN on the client system or in the data path between the server and client. Moreover, since the individual characters represented in the image are rearranged within the image in a pseudo-random manner, any reconstruction of the cursor movement, on the client side, will bear no relation to the location of the keys in any subsequent passcode-entry attempt, and so will be useless.

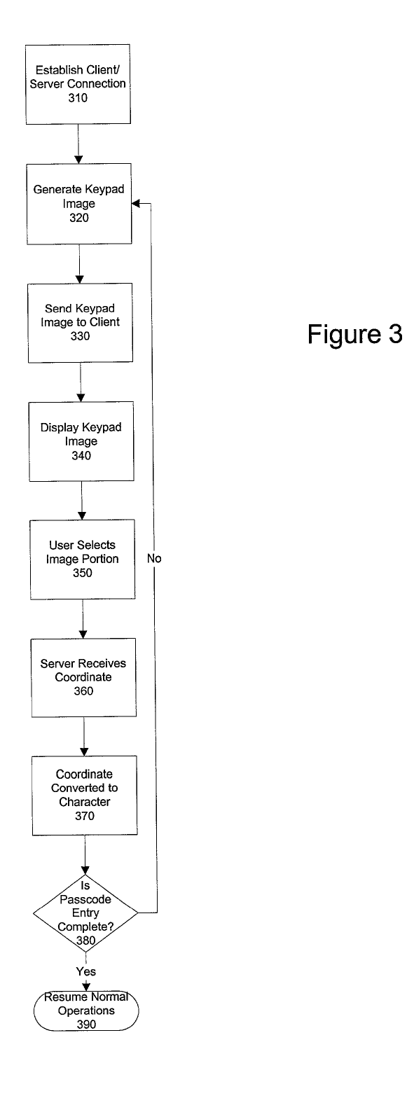

FIG. 3 shows a flowchart of a process in accordance with a preferred embodiment of the present invention. First, a connection is established between the client system and the server system (step 310). The server will then generate a keypad entry image with each graphically-represented key in a pseudo-random position (step 320). Next, the server will send the keypad entry image to the client system (step 330). The client system will display the image to the user (step 340) and the user will select a character or symbol by selecting a location within the image (step 350). The client returns, to the server, the coordinate or code representing the coordinate, within the image, that the user selected (step 360). The server will convert this coordinate to the corresponding character (step 370).

If the passcode entry is complete (step 380), the server will resume its normal passcode validation and operations (step 390). If the passcode entry is not complete, the server system will generate a new keypad image and perform the process again (step 320). The server or client can determine when the passcode entry is complete by receiving an explicit “enter” code from the user, when enough characters have been entered, or by other conventional means.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

While the invention has been particularly shown and described with reference to a preferred embodiment, it will be understood by those skilled in the art that various changes in form and detail may be made therein without departing from the spirit and scope of the invention. For example, the server and client systems described above can be any data processing system connected to communication with another system. The client system can be implemented in any number of data processing system devices, including desktop and laptop computers, mobile telephones, personal digital assistants (PDAs) and other devices, as well as in conventional ATM or telephone systems. The GUI display can be of any number of conventional graphics interfaces, including Apple Macintosh® system, Microsoft Windows® systems, internet browsers such as Netscape Navigator® or Communicator®, Microsoft Internet Explorer®, Mosaic®, or many others. The user input for moving the cursor on the GUI screen can be by any suitable means, such as a mouse, a touchpad, a touchscreen, a lighten, a joystick, a telephone or computer keyboard, or many other means. The user input may also be an eye-tracking device or eye-motion sensing device. It is important to note, however, that the passcode entry described above is not a direct character entry on a conventional keyboard, as these directly-entered characters can be intercepted. The touchpad or keypad image described above can be any graphic image from which discrete portions of the image can be selected by the user to act as a code; this will include conventional alpha-numeric characters, iconic characters and other symbols, as well as any other set of symbols or images which can be graphically represented and rearranged in a pseudo-random fashion. Further, while an image coordinate is used in the above example to indicate to the server system which character is selected on the keypad image, those of skill in the art will recognize that there are many means of indicating which character has been selected, or which portion of the image has been selected.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

It is important to note that while the present invention has been described in the context of a fully functional data processing system and/or network, those skilled in the art will appreciate that the mechanism of the present invention is capable of being distributed in the form of a computer usable medium of instructions in a variety of forms, and that the present invention applies equally regardless of the particular type of signal bearing medium used to actually carry out the distribution. Examples of computer usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

What is claimed is:

1. A method for receiving a secure passcode from a user, comprising the steps of:
generating, in a server system, an image having multiple symbols in pseudo-random locations within the image;
sending the image to a client system;
receiving, from the client system, data indicating a selected portion of the image;
determining an input character corresponding to the selected portion of the image; and
repeating the previous steps to determine subsequent input characters,
wherein each generating step generates a new image with the multiple symbols in different pseudo-random locations.

2. The method of claim 1, further comprising the step of combining the input characters to determine a passcode.

3. The method of claim 1, further comprising the steps of:
combining the input characters to determine a passcode;
comparing the passcode to a stored authorization code; and
sending, to the client system, a result code indicating the result of the comparison.

4. The method of claim 1, wherein the server system authorizes a money transfer operation according to the input characters.

5. The method of claim 1, wherein the symbols are alpha-numeric characters.

6. The method of claim 1, wherein the image represents an alpha-numeric keypad.

7. A method for receiving a secure passcode from a user, comprising the steps of:
displaying, on a graphical user interface, a user input screen with multiple selectable symbols in pseudo-random locations;
receiving, through a cursor-manipulation input, a user selection of one of the multiple selectable symbols;
sending data corresponding to the user selection to a server system;
repeating the previous steps to allow the user to select a series of the multiple selectable symbols,
wherein each displaying step displays the user input screen with the multiple selectable symbols in different pseudo-random locations.

8. The method of claim 7, further comprising the step of combining the series of multiple selectable symbols to determine a passcode.

9. The method of claim 7, further comprising the steps of:
combining the multiple selectable symbols to determine a passode;
comparing the passcode to a stored authorization code; and
selectively authorizing a user operation according to the result of the comparison.

10. The method of claim 7, wherein a money transfer operation is selectively authorized according to the series of multiple selectable symbols.

11. The method of claim 7, wherein the symbols are alpha-numeric charaters.

12. The method of claim 7, wherein the user input screen represents an alpha-numeric keypad.

13. A computer program product having computer-readable code in a computer-readable medium, comprising:
instructions for generating, in a server system, an image having multiple symbols in pseudo-random locations within the image;
instructions for sending the image to a client system;
instructions for receiving, from the client system, data indicating a selected portion of the image;
instructions for determining an input character corresponding to the selected portion of the image; and
instructions for repeating the previous steps to determine subsequent input characters,
wherein each generating step generates a new image with the multiple symbols in different pseudo-random locations.

14. The computer program product of claim 13, further comprising instructions for combining the input characters to determine a passcode.

15. The computer program product of claim 13, further comprising:
instructions for combining the input characters to determine a passode;
instructions for comparing the passcode to a stored authorization code; and
instructions for sending, to the client system, a result code indicating the result of the comparison.

16. The computer program product of claim 13, wherein the server system authorizes a money transfer operation according to the input characters.

17. The computer program product of claim 13, wherein the symbols are alpha-numeric characters.

18. The computer program product of claim 13, wherein the image represents an alpha-numeric keypad.

19. A computer program product having computer-readable code in a computer-readable medium, comprising:
instructions for displaying, on a graphical user interface, a user input screen with multiple selectable symbols in pseudo-random locations;
instructions for receiving, through a cursor-manipulation input, a user selection of one of the multiple selectable symbols;
instructions for sending data corresponding to the user selection to a server system;
instructions for repeating the previous steps to allow the user to select a series of the multiple selectable symbols,
wherein each displaying step displays the user input screen with the multiple selectable symbols in different pseudo-random locations.

20. The computer program product of claim 19, further comprising instructions for combining the series of multiple selectable symbols to determine a passcode.

21. The computer program product of claim 19, further comprising:
instructions for combining the multiple selectable symbols to determine a passode;
instructions for comparing the passcode to a stored authorization code; and
instructions for selectively authorizing a user operation according to the result of the comparison.

22. The computer program product of claim 19, wherein a money transfer operation is selectively authorized according to the series of multiple selectable symbols.

23. The computer program product of claim 19, wherein the symbols are alpha-numeric characters.

24. The computer program product of claim 19, wherein the user input screen represents an alpha-numeric keypad.
